(19) United States
(12) Patent Application Publication
(10) Pub. No.: US 2015/0004917 A1
(43) Pub. Date: Jan. 1, 2015

(54) LOW LEVEL, LOW FREQUENCY SIGNAL MEASUREMENT

(71) Applicant: TRW Automotive U.S. LLC, Livonia, MI (US)

(72) Inventor: David L. Juzswik, Commerce Township, MI (US)

(21) Appl. No.: 14/295,824

(22) Filed: Jun. 4, 2014

Related U.S. Application Data
(60) Provisional application No. 61/841,543, filed on Jul. 1, 2013.

(51) Int. Cl. H04B 17/00

(52) U.S. Cl. CPC H04B 17/00
USPC 455/67.13

(57) ABSTRACT

Apparatus is provided comprising at least one antenna for receiving a low frequency electromagnetic field. A measuring circuit is connected to the at least one antenna for measuring the strength of the low frequency electromagnetic signal received by the antenna. A memory stores a representation of the noise in the output of the measurement circuit. A corrector corrects the measurement provided by the measuring circuit in accordance with the noise representation stored in the memory.

### CROSS REFERENCE TO RELATED APPLICATIONS

This patent application claims priority to and the benefit of co-pending U.S. Provisional Application Ser. No. 61/841,543, filed Jul. 1, 2013, entitled LOW LEVEL, LOW FREQUENCY SIGNAL MEASUREMENT, which is incorporated herein by reference in its entirety.

### FIELD OF THE INVENTION

The present invention is directed to the measurement of low level, low frequency electromagnetic signals and will be specifically described with respect to the use of such measurements in a vehicle remote keyless entry and keyless start system.

### BACKGROUND

In recent years the mechanical locking systems used to secure the doors of a vehicle and to start the vehicle have increasingly been augmented by, and in some cases replaced by, electronic systems. Such systems, sometimes referred to as ‘passive remote keyless entry’ and ‘keyless start’ systems, detect the proximity of an electronic tag or fob carried by the vehicle owner and automatically unlock the vehicle doors and enable the startup of the vehicle. Thus, as the owner approaches the vehicle the doors unlock automatically, and upon entry into the vehicle the owner may start the engine simply by pressing the ‘start’ button. No mechanical key is required either for vehicle entry or operation. Conversely, when the owner leaves the vehicle and walks away, the vehicle doors will automatically lock and the start switch will be disabled.

Interaction between the vehicle-mounted system and the fob is wireless, via a radio link. The vehicle radiates a low frequency (“LF”) electromagnetic field that is sensed by the fob when the fob comes within proximity of the vehicle. Upon detection of the LF field, the fob sends a radio frequency (“RF”) message to the vehicle. Identification codes and encryption ensure that the link between the fob and the vehicle is secure.

It is important for security reasons that the vehicle doors unlock only when the fob is very close to the vehicle, typically within one or two meters of the door. In some systems, the fob distance from the vehicle is determined from the strength of the LF field at the fob, since the strength of the field at the fob will increase as the fob approaches the vehicle. In such systems, the strength of the LF field at the fob may be measured by the fob, and the measured field strength may then be sent back to the vehicle via the RF link. The keyless entry and keyless start system on the vehicle receives the field strength measurement and compares the measured field strength against a threshold to determine when to unlock the vehicle doors. US Patent Application 2012/0062358 describes an LF antenna for use in a passive keyless entry system of this general sort. The described antenna has a single core surrounded by multiple windings such that the antenna combines the functions of a three dimensional (3D) LF antenna and an RF antenna.

To improve the accuracy of the determination of fob distance, the fob is tested and calibrated during manufacture, so that the relationship between actual LF source distance and measurement output is linear and has no offset. Even with this calibration, the field strength measurement at moderate distances from the vehicle may be unreliable, since the field strength at those distances is near the noise floor of the analog-to-digital convertor in the fob.

### SUMMARY OF THE INVENTION

The present invention provides apparatus comprising at least one antenna for receiving a low frequency electromagnetic field. A measuring circuit is connected to the at least one antenna for measuring the strength of the low frequency electromagnetic signal received by said antenna. A memory stores a representation of the inherent noise in the output of the measurement circuit. A corrector circuit corrects the measurement provided by the measuring circuit in accordance with the noise representation stored in memory.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a block diagram of a system in which a fob incorporating the present invention may be used;

FIG. 2 is a flow chart of a first version of the calibration process performed during the course of manufacture of the fob;

FIG. 3 is a flow chart of a second version of the calibration process performed during the course of manufacture of the fob; and,

FIG. 4 is a flow chart of a portion of the process performed by the fob during normal operation.

### DETAILED DESCRIPTION

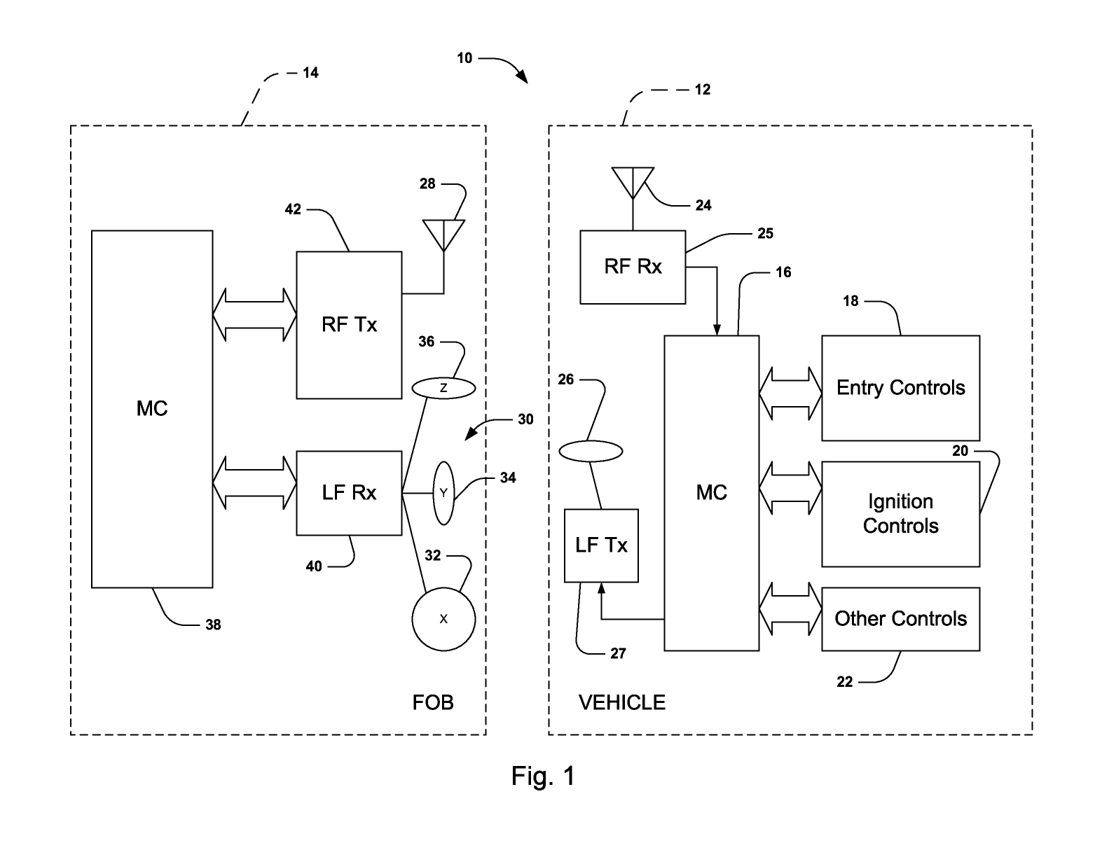

Referring to FIG. 1, a keyless access system 10 for a vehicle is shown.

As will be described hereinafter, the system 10 may implement a keyless entry function and/or a keyless start function. The present invention will beneficially find use in a system such as this, but it is not limited to use in such a system. It is anticipated that the present invention will be similarly useful in various other systems in which the amplitude of low level LF fields must be accurately measured.

The system 10 includes a vehicle-mounted controller 12 that communicates with a portable, battery-operated fob 14. The fob 14 is small and will conveniently be carried close at hand by the vehicle operator in his/her pocket or hand, on a lanyard or in a bag, etc.

The vehicle-mounted controller 12 is of known construction and includes a microcontroller 16 including a system clock generator, a central processing unit (CPU), program memory (ROM), random access memory (RAM), programmable timers, analog-to-digital and digital-to-analog convertors, interrupt controllers, serial interfaces, and so on. Microcontroller 16 operates various vehicle systems including entry controls 18, ignition controls 20, and other systems 22. The systems are illustrated as controlled directly by microcontroller 16 via individual control lines but more commonly the systems will be indirectly controlled via a body control module (not shown). Where a body control module is used, microcontroller 16 will send messages to the body control module via a vehicle communication bus and the body control module will respond to the messages by causing the vehicle systems to perform the commanded actions. Entry controls 18 will control vehicle door locks and possibly also door actuators (e.g. actuators for side panel doors or a rear hatch). Ignition controls 20 will respond to microcontroller 16 and to a ‘start’ button (not shown) on the dash of the vehicle to control the starting and stopping of the engine of the vehicle. The other systems 22 operated by microcontroller 16 will typically include the vehicle horn and interior and/or exterior lights.

Microcontroller 16 operates controlled systems 18, 20, and 22 in response to radio communications exchanged with fob 14. For this purpose, vehicle controller 12 includes an omnidirectional RF antenna 24 and RF receiver 25 for receiving RF messages from the fob 14 on a carrier frequency of, for example, 315 MHz, and a directional LF antenna 26 and LF transmitter 27 for generating a localized LF field at a frequency of, for example 125 kHz, for triggering fob 14 to send an RF message. The LF antenna is typically a coil wrapped around a form, where the form often has a ferrite core.

Fob 14 is similarly equipped with RF and LF antennas 28 and 30 respectively. Rather than having a single LF antenna, however, fob 14 includes three LF antennas 32, 34, and 36 oriented within fob 14 in respective directions X, Y and Z that are mutually orthogonal to one another. LF antennas 32, 34, and 36 are again typically coils wrapped around a core. For compactness, the LF antennas are wrapped in different directions X, Y, and Z around a common form that, again, may have a ferrite core. Such an arrangement is known per se, with one example being shown in published patent application US 2012/0062358 (Nowottnick).

Three LF antennas are included in fob 14 because the strength of the received LF signal will depend not only upon distance separating the receiving and emitting antennas, but also upon the relative alignment of the axes of the two antennas. Controller 12 is fixed to the vehicle and thus its orientation is known. The orientation of fob 14 is unknown, however, and will vary from time to time and indeed from second to second. By combining the outputs of three mutually orthogonal antennas via a three axis root sum square method, the LF signal can be received at optimal strength regardless of the relative orientation of the vehicle and the fob.

In the example embodiment illustrated in FIG. 1, fob 14 contains a microcontroller 38. The use of a microcontroller is exemplary only, however, and fob 14 may instead be operated by other controller circuitry such as, for example, an application specific integrated circuit (“ASIC”) configured as a state machine. As with microcontroller 16 of controller 12, microcontroller 38 contains a system clock generator, a central processing unit (CPU), program memory (ROM), random access memory (RAM), programmable timers, an analog-to-digital convertor (ADC), a digital-to-analog convertor (DAC), interrupt controllers, serial interfaces, and so on. An LF receiver 40 receives the signals from the three LF antennas 30 and supplies microcontroller 38 with baseband signals for each antenna. The LF baseband signals track the amplitude of the LF signal as received by the respective antenna. An RF transmitter 42 receives messages from microcontroller 38, modulates an RF carrier with the message, and transmits the modulated RF carrier signal via omnidirectional RF antenna 28.

Although not illustrated in FIG. 1, fob 14 may be equipped with one or more manual buttons that may be pressed by the vehicle operator to manually initiate certain vehicle operations via the messages composed by microcontroller 38 and broadcast by RF transmitter 42. The purpose and functioning of such buttons is known and will not be described herein.

As stated previously, controller 12 must determine the location of fob 14 to allow or disallow certain requested actions such as starting the vehicle or opening a door. To accomplish this, microcontroller 16 establishes an LF magnetic field in the vicinity of the vehicle by means of LF antenna 26 and LF transmitter 27. The LF field will be a continuous wave signal, of constant amplitude to facilitated measurement of the LF field intensity. Periodically, however, the LF field will be modulated with security information (e.g., a vehicle identification code) to prevent spurious responses from unrelated fobs.

When fob 14 is close to the vehicle, the LF antennas 30 respond to the LF magnetic field and the fob recovers the security information from the LF field. If the security code matches security information stored in the fob, the fob proceeds to measure and transmit the LF signal amplitude information. LF receiver 40 supplies amplitude of the continuous wave signals to an ADC within microcontroller 38. As will be described in more detail below, microcontroller 38 adjusts the amplitude information derived from each antenna in accordance with respective stored offset and linearization factors. Microcontroller 38 combines the resulting linearized amplitude signals of the three LF antennas via the known three-axis root-sum-squared method to provide a calculated overall measure of the amplitude of the LF field. Microcontroller 38 transmits the calculated root-sum-squared LF signal strength measure back to controller 12 by composing a datagram including, among other things, the measurement information and forwarding the datagram to RF transmitter 42 for transmittal. The datagram will be encrypted using methods known per se for enhanced security.

Controller 12 receives the message via receiver 25, decrypts the datagram, and recovers the measured signal strength information from the message. Controller 12 evaluates the measured signal strength to determine whether the fob is near enough to the vehicle to allow door unlocking or other operations.

The evaluation of the LF signal strength by controller 12 may be as simple as comparison of the amplitude (as received from fob 14) with a stored threshold representing a minimum amplitude required for enablement of door unlocking or vehicle start functions. The evaluation may, however, be more sophisticated. Controller 12 may establish LF fields sequentially through two or more LF antennas, one at a time, in which case the actual position of fob 14 may be established via triangulation using the multiple signal strengths returned to controller 12 by the fob.

For passive entry the typical range requirement is on the order of 1.5 to 2 meters. In other words, the entry system should open the doors when the fob is within that distance from the door of the vehicle. The LF field strength falls off as the cube of the distance from the LF antenna, hence there is a dramatic decrease in field strength as the separation distance between the fob and the vehicle increases. At the specified distance of 1.5 to 2 meters, the LF amplitude signal provided by LF receiver 40 is near the noise floor of the ADC within microcontroller 38. The nearness of the signal amplitude to the noise floor of the ADC can produce large errors in combined total signal strength, when the three orthogonal amplitudes are combined with the traditional root-sum-squared method.

In order to correct the large error incurred in the root sum squared method when the signal to be measured is near the noise floor of the measuring device, the present invention contemplates that a sum squared compensation factor (“SSCF”) will be determined just above the nose floor.

The compensation factor will be stored in the fob and applied to the calculated sum squared value. Consider, for example, a situation in which the noise floor of the signal measuring device is 0.7 nano-Teslas (nT), after linearization of each sensor axis, and the actual root-sum-squared amplitude of the field is 1 nT, only slightly above the noise floor. If the measuring device has one LF antenna axis perfectly aligned to the field being measured, the calculated sum squared value will be (1)²+(0.7)²+(0.7)²=1.98 because the signal contribution from the other two axes will be noise only. The square root of the sum of the squares will thus be 1.4, which represents a 40% error above the actual value of field strength of 1 nT.

To correct for this measurement noise error, the error at the sum squared level (1.98−1=0.98) is stored in the fob as a sum squared compensation factor, peculiar to that fob, and is subsequently subtracted from all calculated sum-squared values prior to the square root being taken. Thus, the uncorrected value of 1.98 will have the correction factor of 0.98 subtracted, giving both a corrected sum squared value and a root sum squared value of 1.0 and thereby effectively eliminating the noise error. The sum squared correction factor is applied to all signal levels, high and low, but has a much smaller corrective effect at higher signal levels, as it should. At a 4 nT field, for example, the uncorrected sum squared value would be 16+0.49 +0.49=16.98. The corrected sum squared value would then be 16.98−0.98=16, for a root sum squared value of 4.

In practice the sum squared compensation factor will be calculated once, during the fob manufacturing process.

It is known to calibrate the LF amplitude measurements of a newly manufactured fob by mounting the fob inside a test box and applying to the fob LF signals of known direction and strength. Specifically, LF fields of varying amplitude are provided in alignment with each of the LF antennas, one after another. The amplitudes measured by the ADC for each respective LF antenna in the fob are retrieved from the fob by an external tester, which generates a matrix of corrected values that are linearized and offset-adjusted. The external tester then downloads the matrix of corrected values into the nonvolatile memory of the fob. When the fob is subsequently used in the field, the field strength measured in each axis is used as an index to access the matrix and retrieve from the matrix a corresponding calibrated value that is both linearized and offset adjusted.

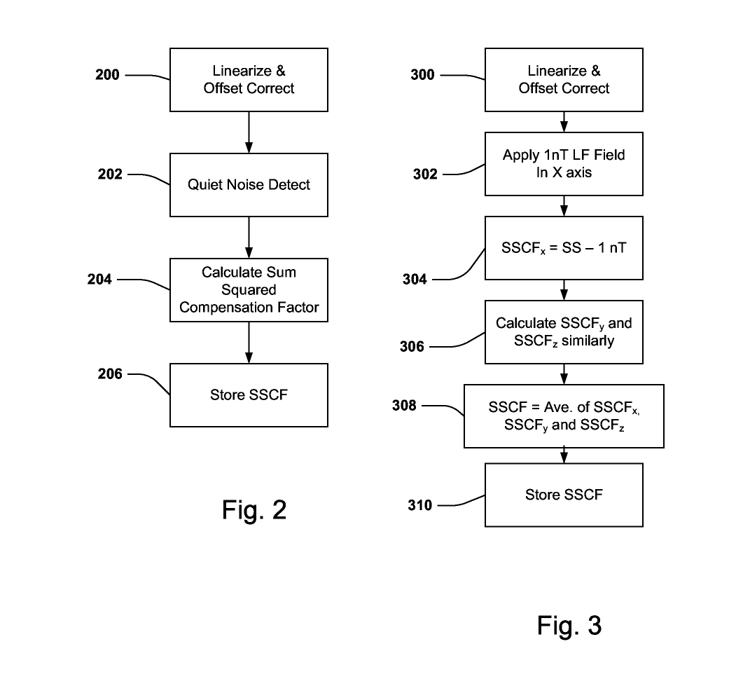

To implement the present sum squared compensation factor, the calibration process described above is augmented with an additional fob testing and calibration process with the fob still in the test box. The additional process may take a variety of forms, one of which is graphically represented in the flow chart of FIG. 2.

In the version shown in FIG. 2, the sum squared compensation factor is calculated by measurement of noise in a magnetically quiet environment. After linearization and offset adjustment (step 200), the external test fields are all removed so that the fob is in a magnetically quiet environment, with no applied magnetic field. The external tester then retrieves from the fob amplitude measurements for each of the LF antennas (step 202). As no external magnetic field is being applied at this time, the measurements that are thus retrieved will reflect only noise. The external tester will calculate from the measurements a sum squared value (step 204). That sum squared value, which is a single value for each fob representing the sum squared compensation factor for that fob, is then downloaded into the fob and stored in nonvolatile memory (step 206).

LF receiver 40 will be a functional block within a large scale integrated circuit, and will have separate amplifier channels for each LF coil. Although the noise floor for each of the coil amplifier channels in the integrated circuit are substantially similar, the internal amplifier noise floor will be different for different integrated circuits. Thus, it is contemplated that the sum squared compensation factor will be determined independently for each fob.

Although the implementation process as described uses the external tester to take noise readings and calculate the sum squared compensation factor, in fact the microcontroller in the fob can be programmed to perform this process entirely on its own during the fob testing and noise calibration step. In that case, upon removal of all external test fields, the fob will be triggered to calculate and store the compensation factor in the same manner described above with respect to the external tester.

An alternate, and presently preferred method of calculating a sum squared compensation factor is graphically illustrated in the flow chart of FIG. 3. In the version shown in FIG. 3, the sum squared compensation factor is determined in a nominal applied LF field, rather than in a quiet environment with no applied LF field. After linearization and offset adjustment (step 300), a known external test field of 1 nT is applied in alignment with the coil antenna 32 whose axis is oriented in the x direction (step 302). The square of the sum of the signals from all three coils is then calculated to produce a sum squared value that, in a noise free environment, would equal “1” (1²+0²+0²=1). As the environment is not noise free, the actual sum squared value will be somewhat greater than “1”. A first SSCF value (denoted as SSCF_{X} in the figure, since it is derived while a field is applied in the “x” direction) is determined by subtracting one from the actual sum squared value (step 304). Second and third SSCF values (denoted as SSCF_{y} and SSCF_{z}) are then determined by repeating steps 302 and 304, but with the applied LF field aligned with each of the other two coil antennas 34 and 36 in turn (for convenience, illustrated as a single step 306). The three SSCFₙ values are then averaged to produce the final SSCF value which, as in the first version of the process, is downloaded into the fob and stored in nonvolatile memory (step 310).

Additional steps may be added to the process to verify the SSCF calibrations thus performed by applying various test LF fields to the fob.

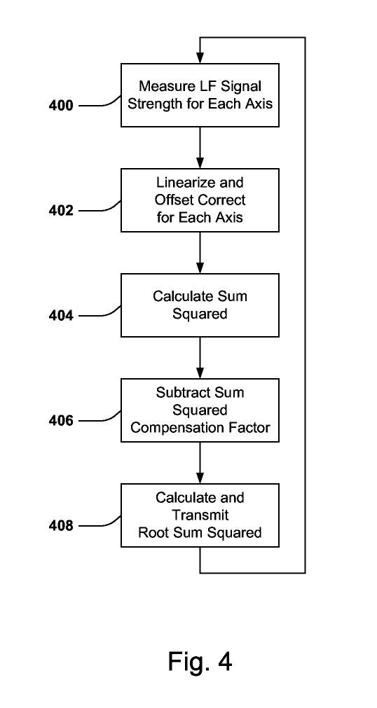

When the fob is subsequently used in the field, the sum squared compensation factor will be subtracted from the measured sum squared value prior to calculation of the square root, with the result being that the noise factor is effectively eliminated. The LF measurement process performed by fob 14 is graphically represented in the flow chart of FIG. 4. For simplicity, the FIG. 4 flow chart depicts only those steps that relate to the LF noise correction described herein. It will be appreciated that many additional processes and steps, all known per se, are performed by the fob in the course of performing its various vehicle control functions.

As shown in FIG. 4 and previously described, the fob first measures the signal amplitude of the LF signal received by each of the three LF antennas 30 (step 400). The resulting measurements are used as indexes to access the linearization and offset correction matrix stored in fob nonvolatile memory, thereby providing linearized and offset corrected measurement values (step 402). The fob then calculates a sum squared value from those linearized and offset corrected values (step 404). The stored sum squared compensation factor is then subtracted from the calculated sum squared value (step 406). The square root of the resulting difference is then calculated and a message including the measured LF signal strength is transmitted via RF to the vehicle controller 12 (step 408). The LF amplitude calculation and transmission steps are repeated continuously.

Vehicle controller 12 will use the measured LF signal strength to determine the location of fob 14. Vehicle operations will be enabled or disabled depending upon the determined location of the fob.

The invention has been described in connection with a particular keyless entry/passive start system, but is not limited to the specifics of the described system. The invention could be used in almost any permutation of the various known implementations of keyless entry and passive start systems. For example, the invention could be used in a system employing bidirectional LF and/or RF links rather than the unidirectional links described. Moreover, the various noise compensation steps could be performed in a somewhat different manner while still achieving the same result. For example, the steps 406 and 408 (FIG. 4) could be performed in vehicle controller 12 rather than fob 14, provided that the data for performing those steps (the “sum of the squares” calculated in step 404 and the stored “sum squared compensation factor”) is first transmitted to vehicle controller 12.

Method and apparatus have thus been described for improving the measurement of LF signal strength. The invention will be particularly helpful in avoiding significant measurement errors where the LF signal strength is near the noise floor of the signal amplitude measuring device, as in most passive keyless entry systems. A noise contribution value is measured and stored in memory. The stored noise contribution value is subsequently subtracted from the measured signal amplitude value in order to provide a noise-corrected value. In the described embodiment, signal strength in three dimensions is calculated through use of multiple antennas whose outputs are combined to produce a root sum squared total signal amplitude level. The noise contribution value is subtracted out from the sum of the squares of the individual signal amplitudes, before the square root of the sum is taken.

The details of one or more embodiments of the invention are set forth in the accompanying drawings and the description below. Other features, objects, and advantages of the invention will be apparent from the description and drawings, and from the claims.

Having described the invention, the following is claimed:

1. Apparatus comprising at least one antenna for receiving a low frequency electromagnetic field, a measuring circuit connected to said at least one antenna for measuring the strength of the low frequency electromagnetic signal received by said antenna, a memory for storing a representation of the noise in the output of the measurement circuit, and a corrector for correcting the measurement provided by the measuring circuit in accordance with said noise representation stored in said memory.

2. Apparatus as set forth in claim 1, wherein said at least one antenna comprises three antennas oriented in mutually orthogonal directions, each antenna providing a respective low frequency signal, and where said measuring circuit includes a calculator for determining the sum of the squares of said respective low frequency signals provided by said three antennas.

3. Apparatus as set forth in claim 2, wherein said corrector reduces said sum of the squares in accordance with said noise representation stored in memory, and further wherein said corrector provides a compensated signal corresponding to the square root of the reduced sum of the squares.

4. A self-contained, battery operated fob for wirelessly controlling access to a vehicle, comprising three antennas for receiving a low frequency electromagnetic field, said three antennas being oriented in mutually orthogonal orientations relative to one another, a measuring circuit connected to said three antennas for measuring the strength of the low frequency electromagnetic signal received by said three antennas, a memory for storing a representation of the noise in the output of the measurement circuit, and a corrector for correcting the measurement provided by the measuring circuit in accordance with said noise representation stored in said memory.

5. A self-contained battery operated fob as set forth in claim 4, wherein said measuring circuit comprises a sum squared circuit for providing a sum squared output corresponding to the sum of the squares of the signals received by said three antennas, and said corrector reduces said sum squared output in accordance with said noise representation stored in said memory.

6. A self-contained battery operated fob as set forth in claim 5, further comprising a root calculator for calculating the square root of the corrected sum squared output provided by said corrector, and a transmitter for transmitting the resulting corrected root sum squared output to a vehicle.

7. A self-contained battery operated fob as set forth in claim 4, wherein said measuring circuit linearizes and offset-corrects said measured strengths of the low frequency electromagnetic signal received by said three antennas.

8. A process for reducing the noise contribution in low frequency amplitude measurements, comprising the steps of determining a noise contribution introduced by a particular piece of low frequency measurement apparatus, storing the noise contribution, measuring the amplitude of a low frequency signal with said particular piece of apparatus, and adjusting the measurement in accordance with the stored noise contribution.

9. A process for reducing the effect of noise contributions in the measurement of the amplitude of low frequency signals received by a vehicle access fob containing a low frequency amplifier, comprising the steps of determining a noise contribution introduced by the specific said low frequency amplifier contained in said fob, storing said noise contribution in the associated said fob, using the low frequency amplifier in the measurement the amplitude of a low frequency signal, and adjusting the measurement in accordance with said stored noise contribution.

10. A process as set forth in claim 9, wherein said step of adjusting the measurement comprises the step of subtracting said stored noise contribution from said measurement.

11. A process as set forth in claim 9, wherein said step of determining a noise contribution comprises the steps of applying a low frequency signal of known strength to said fob in multiple orientations, measuring the amplitude of said low frequency signal in each said applied orientation as received at said fob, subtracting the known strength of said applied low frequency signal from each said measurement to produce difference values corresponding to noise arising in each orientation, and calculating said noise contribution from said difference values.

12. A process as set forth in claim 9, wherein said step of determining a noise contribution comprises the steps of measuring the amplitude of received low frequency signal when no low frequency signal is present, and calculating said noise contribution from said measured amplitude.
